(19) United States
(12) Patent Application Publication
(10) Pub. No.: US 2015/0316010 A1
(43) Pub. Date: Nov. 5, 2015

(54) 3-Way Valve Assembly

(71) Applicant: Delphi International Operations Luxembourg S.A.R.L, Bascharage (LU)

(72) Inventors: Anthony Lewis, Downend, Bristol (GB); Craig Iliffe, Westbury Park, Bristol (UK); Peter Lloyd, Ebley, Stroud, Gloucestershire (UK); Mark S. Graham, Westbury-On -Trym, Bristol (UK)

(73) Assignee: Delphi International Operations Luxembourg S.A.R.L, Bascharage (LU)

(21) Appl. No.: 14/440,396

(22) PCT Filed: Oct. 24, 2013
(86) PCT No.: PCT/EP2013/072290

§ 371 Date: May 4, 2015

(30) Foreign Application Priority Data
Nov. 5, 2012 (EP) 12191314.9

(51) Int. Cl. F02M 55/00; F02M 53/04; F02M 63/00

(52) U.S. Cl. CPC F02M 55/007; F02M 63/0045; F02M 63/0015; F02M 53/046; F02M 55/002

(57) ABSTRACT

The present invention relates to a 3-way valve assembly (102; 202; 302) for a fuel injector (101; 201; 301). The valve assembly (102; 202; 302) includes a valve body (103; 203; 303), a movable valve member (104; 204; 304), and an armature (113; 213; 313) for actuating the valve member (104; 204; 304). The armature (113; 213; 313) is disposed in an armature cavity (115; 215; 315). The valve member (104; 204; 304) is configured to control an operating pressure in a control chamber (105). The valve body (103; 203; 303) includes a bore (117; 217; 317) in which the valve member (104; 204) is disposed. A leak vent (121; 221) is provided for venting fuel leaking through the bore (117; 217) past said valve member (104; 204). In an alternate embodiment, a partitioning member (333) is disposed in the armature cavity (315).

### CROSS REFERENCE TO RELATED APPLICATIONS

This application is a national stage application under 35 U.S.C. 371 of PCT Application No. PCT/EP2013/072290 having an international filing date of 24 Oct. 2013, which designated the United States, which PCT application claimed the benefit of European Patent Application No. 12191314.9 filed on 5 Nov. 2012, the entire disclosure of each of which are hereby incorporated herein by reference.

### TECHNICAL FIELD

The present invention relates to a valve assembly for a fuel injector; and a fuel injector.

### BACKGROUND

It is known to provide a fuel injector with a nozzle control valve to control actuation of a needle valve. A nozzle control 3-way valve 1 for a known fuel injector 2 is shown in FIG. 1. The nozzle control valve 1 includes a valve member 3 for controlling fuel pressure in a control chamber 4 to control the actuation of a needle valve 5. The valve member 3 is movably mounted in a valve body 6. The control chamber 4 is maintained in fluid communication with a high pressure fuel line P_{HIGH}. The valve member 3 is displaced to an open position to open a low pressure return line P_{LOW} to reduce the fuel pressure in the control chamber 4, thereby allowing the needle valve 5 to lift and open one or more injection ports 7 for injecting fuel into a cylinder 8 of an internal combustion engine. The valve member 3 is displaced to a closed position to close the low pressure return line P_{LOW}, thereby allowing the needle valve 5 to be seated in a valve seat 9 (for example under a bias applied by a spring element 10) to close the injection ports 7.

As shown in FIG. 2a, an electromechanical actuator 11 is provided for actuating the valve member 3. The electromechanical actuator 11 comprises a solenoid 12 for selectively displacing the valve member 3 to said open position; and a spring member 13 for biasing the valve member 3 to said closed position. The solenoid 12 is configured to cooperate with an armature 14 fixedly mounted to the valve member 3 to control actuation of the nozzle control valve 1. The armature 14 is disposed in an armature cavity 15 and arranged such that a gap 16 (sometimes referred to as an ‘air gap’) is provided between the solenoid 12 and the armature 14, as shown in FIG. 2. When the solenoid 12 is energised, the armature 14 and the valve member 3 are displaced towards the solenoid 12 and the gap 16 is closed. The spring member 13 biases the armature 14 away from the solenoid 12 when the solenoid 12 is de-energised.

As mentioned above, the control chamber 4 is in fluid communication with a high pressure fuel supply line P_{HIGH} (in which the fuel pressure may be as high as 3500 bar). In contrast, the armature cavity 15 is maintained at a relatively low pressure (for example, approximately 6 bar). The valve member 3 is movably mounted in a bore 17 formed in the valve body 6, the bore 17 extending from a valve chamber 18 to the armature cavity 15. The clearance between the valve member 3 and the bore 17 is very small (for example, a 1 μm diametric clearance) to establish a seal between the control chamber 4 and the armature cavity 15. However, the permanent large difference in fuel pressure generates permanent leakage occurs from the valve chamber 18 past the valve member 3 into the armature cavity 15 (so-called ‘stem leakage’).

The dramatic drop in pressure as the leaked fuel enters the armature cavity 15 results in a considerable elevation in its temperature. This high temperature can break down the microstructures of the fuel and result in deposits forming around the armature cavity 15, for example resulting in a build-up of deposits on the armature 14. These deposits build up over time, depending on the leak rate (determined by the clearance between the bore 17 and the valve member 3), the fuel quality and the operating temperature.

As shown in FIG. 2b, the fuel deposits 19 accumulate in two locations of interest. Firstly, on top of the armature 14 in the gap 16 provided between the armature 14 and the solenoid 12. Secondly, deposits accumulate on the bottom face of the solenoid 12 opposing a top face of the armature 14. The deposits change the size of the gap 16 and this can affect the hydraulic damping effect as the armature 14 is displaced toward the solenoid 12. The result of deposits gathering on these faces can be a change in the dynamic performance within the injector 2. Under certain conditions this can affect the timing and quantity of fuel entering the combustion chamber in an engine.

The present invention sets out to help ameliorate or overcome at least some of the problems associated with prior art systems.

### SUMMARY OF THE INVENTION

Aspects of the present invention relate to a 3-way valve assembly of a fuel injector; and a fuel injector.

In a further aspect of the present invention, there is provided a 3-way valve assembly of a fuel injector, the valve assembly comprising: a movable valve member configured to control an operating pressure in a control chamber; an armature for actuating the valve member, the armature being disposed in an armature cavity; and a valve body having a bore in which the valve member is disposed, the 3-way valve being configured so that a permanent leakage of fuel occurs between the valve member and the valve body; wherein a leak vent is provided for venting fuel leaking through the bore past said valve member. The leak vent can be arranged in fluid communication with said bore. In use, at least some of the fuel that leaks past the valve member can exit through the leak vent. The volume of fuel entering the armature cavity past the valve member (i.e. stem leakage) can be reduced, thereby reducing fuel deposits on the armature and/or an actuating solenoid.

The leak vent can be formed in the valve body. The leak vent can comprise a vent bore formed in the valve body, for example extending transversely. Alternatively, or in addition, the leak vent can be formed in the valve member. The leak vent can comprise an axial vent bore formed in the valve member.

The leak vent could comprise an inlet in fluid communication with the armature cavity, for example to vent fuel which has leaked into the armature cavity. Alternatively, the leak vent can comprise an inlet that opens into the bore formed in the valve body. The inlet can open directly into the bore to allow fuel, in use, to exit the bore through the leak vent. A gallery can be formed in the valve body and/or the valve member. The inlet of the leak vent can open into the gallery. The gallery can comprise an annular chamber extending around the valve member.

The bore in the 3-way valve body can extend from the armature cavity to a valve chamber. The leak vent can be in communication with an outlet from the valve chamber. For example, the outlet can be a low pressure fuel drain. This is particularly suitable when the leak vent is formed in the valve member. For example, the outlet can be located within a conical valve to provide a fluid pathway to the outlet when the conical valve is closed. The outlet can, for example, be provided in the valve body or in a piston guide for movably mounting the piston needle valve.

A partitioning member could be provided in the armature cavity, for example to form a holding chamber. A leak vent could be provided in fluid communication with said holding chamber. The partitioning member could be a heat shield.

In a further aspect of the present invention, there is provided a valve assembly for a fuel injector, the valve assembly comprising: a movable valve member configured to control an operating pressure in a control chamber; and an armature for actuating the valve member, the armature being disposed in an armature cavity; wherein a partitioning member is disposed in the armature cavity; and a leak vent is provided in fluid communication with said armature cavity.

The partitioning member can form a holding chamber within the armature cavity. The holding chamber can be partially or completely sealed from the remainder of the armature cavity. In use, the partitioning chamber can thereby inhibit the flow of high temperature fuel over the armature. The accumulation of fuel deposits can thereby be reduced.

The leak vent can be provided in fluid communication with the holding chamber formed within the armature cavity by the partitioning member. The leak vent can open directly into the holding chamber, for example.

The partitioning member can be fixedly or movably mounted in the armature cavity. The partitioning member can be disposed between the armature and the valve body. The valve assembly can comprise a solenoid for actuating the valve member. The solenoid can be positioned on a first side of the armature such that a gap is maintained between the solenoid and the armature. The partitioning member can be located on a second side of the armature, opposite to the first side.

The partitioning member can be mounted to the valve member. Alternatively, the partitioning member can be fixedly mounted in the armature cavity. An aperture can be formed in the partitioning member. The valve member can extend through the aperture in the partitioning member.

The partitioning member can be configured, in use, to direct fuel leaked past the valve member away from the armature. The partitioning member can optionally direct leaked fuel towards the leak vent.

The partitioning member can be a heat shield. For example, the partitioning member can be formed from one or more materials having thermal insulating properties.

The valve assembly described herein can be a nozzle control valve. The control chamber can be a nozzle control chamber for controlling actuation of a needle valve in a fuel injector.

In a yet still further aspect of the present invention, there is provided a 3-way valve assembly of a fuel injector, the valve assembly comprising a valve body; a movable valve member for controlling an operating pressure in a control chamber; and an armature, disposed in an armature cavity, for actuating the valve member; wherein a heat shield is disposed in the armature cavity. A leak vent can optionally be provided in fluid communication with said armature cavity. The heat shield could, for example, form a partition within the armature cavity.

The heat shield can be fixedly mounted in the armature cavity or could be mounted to the valve member.

In a further aspect of the present invention, there is provided a fuel injector comprising a nozzle control valve as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. For example, features described with reference to one embodiment are applicable to all embodiments, unless such features are incompatible.

### BRIEF DESCRIPTION OF THE DRAWINGS

Embodiments of the present invention will now be described, by way of example only, with reference to the accompanying figures, in which:

FIGS. 1, 2a and 2b show schematic representations of a known fuel injector and nozzle control valve;

FIG. 3 shows a schematic representation of a fuel injector incorporating a nozzle control valve in accordance with the present invention;

FIG. 4 shows a cross-sectional view of a portion of the nozzle control valve shown in FIG. 3;

FIG. 5 shows a valve pin in accordance with a second embodiment of the present invention; and

FIG. 6 shows a cross-sectional view of a portion of a nozzle control valve in accordance with a third embodiment of the present invention.

### DETAILED DESCRIPTION OF AN EMBODIMENT

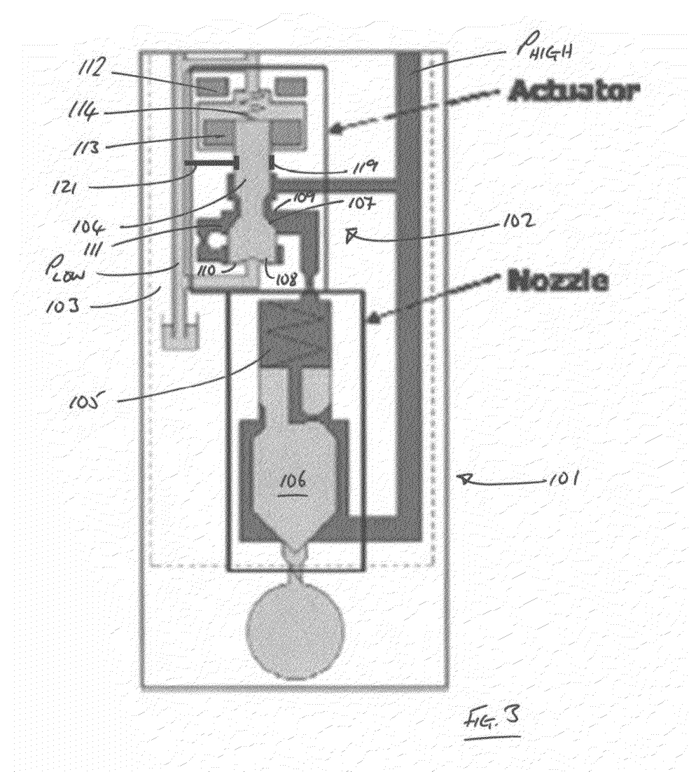

A fuel injector 101 having a 3-way nozzle control valve 102 in accordance with a first embodiment of the present invention is shown in FIG. 3. The 3-way nozzle control valve 102 is configured to control actuation of the fuel injector 101 to control the injection of fuel into a cylinder of an internal combustion engine. The fuel injector 101 in the present embodiment is adapted for diesel fuel.

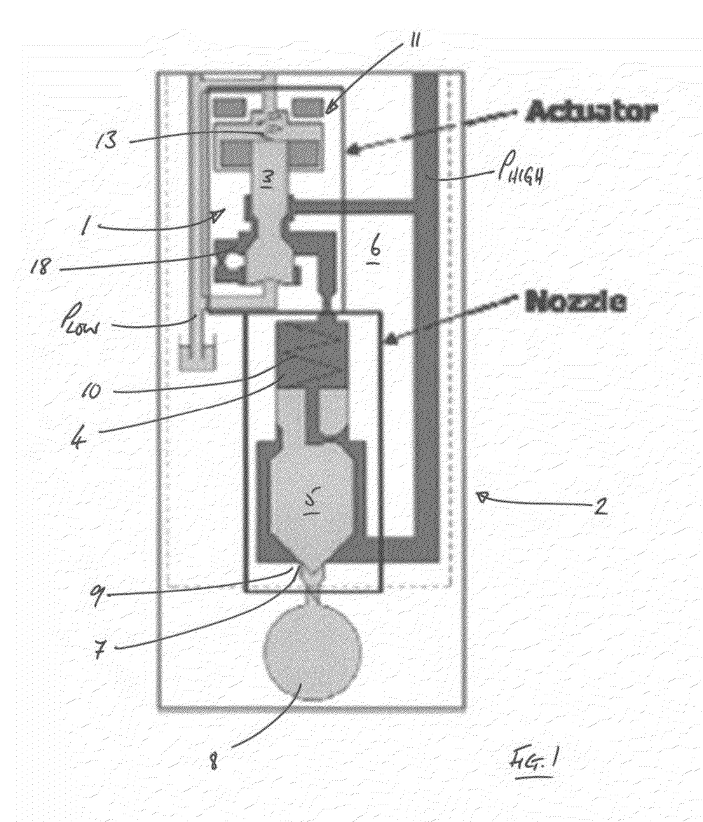

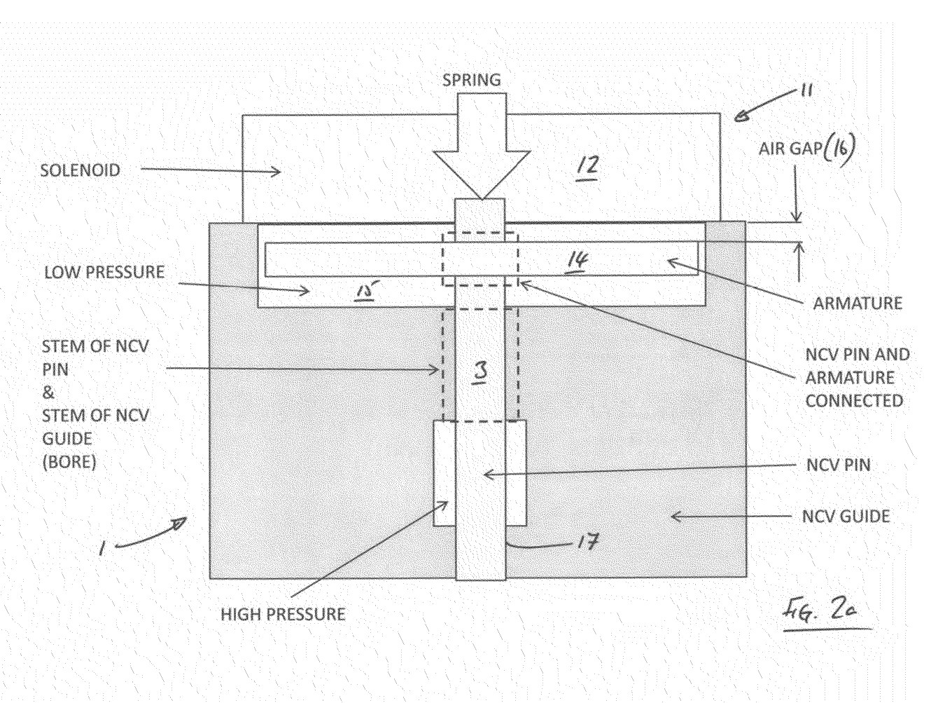

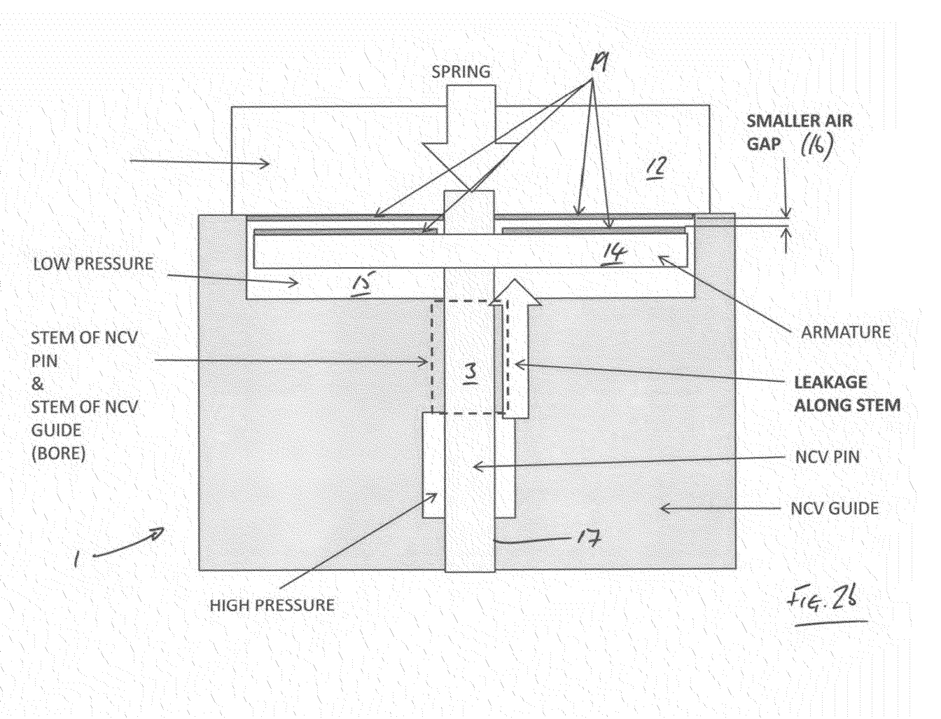

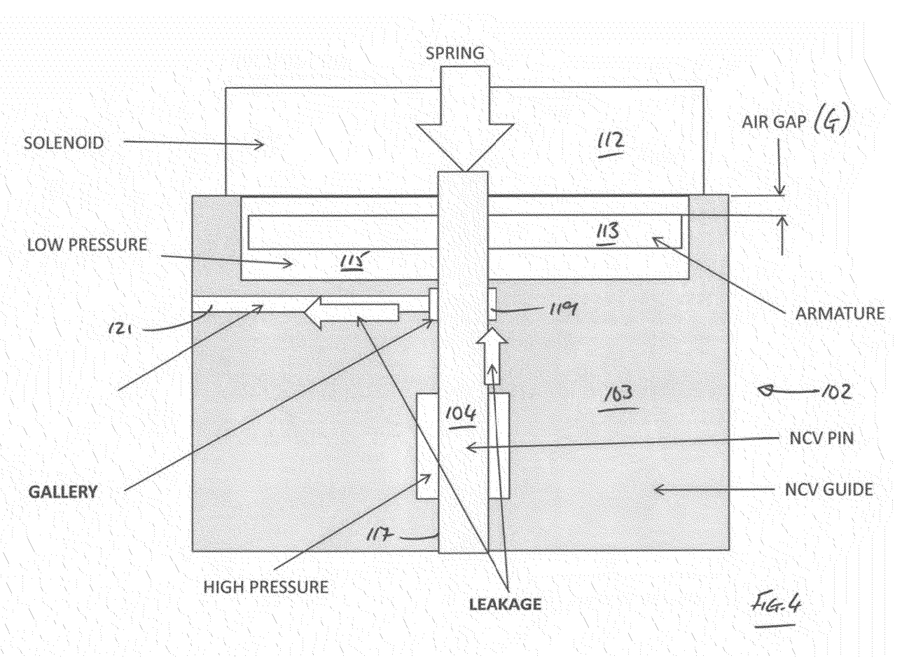

The nozzle control valve 102 is largely unchanged from the prior art arrangement described herein with reference to FIGS. 1 and 2. As shown in FIG. 4, the 3-way nozzle control valve 102 comprises a valve body 103 and a movable valve member 104 for controlling fuel pressure in a control chamber 105 to control the opening and closing of a needle valve 106. The valve member 104 is typically in the form of a valve pin. The valve member 104 comprises first and second valves 107, 108 for cooperating with respective first and second valve seats 109, 110 formed in the valve body 103. The first and second valves 107, 108 are disposed in a valve chamber 111 formed in the valve body 103.

The control chamber 105 is maintained in fluid communication with a high pressure fuel line P_{HIGH} which typically operates at pressures of up to 3500 bar. The valve member 104 is displaced to an open position (when the first valve 107 is seated and the second valve 108 is unseated) to open a low pressure return line P_{LOW} to reduce the fuel pressure in the control chamber 105, thereby allowing the needle valve 106 to lift and open one or more injection ports. The valve member 104 is displaced to a closed position (when the first valve 107 is unseated and the second valve 108 is seated) to close the low pressure return line P_{LOW}, thereby allowing the needle valve to be seated in a valve seat (for example under a bias applied by a spring element 114) to close the injection port(s).

An electromechanical actuator 109 is provided for actuating the valve member 104. The electromechanical actuator 109 comprises a solenoid 112 for selectively displacing the valve member 104 to its open position; and a spring member for biasing the valve member 104 to its closed position. The solenoid 112 is configured to cooperate with an armature 113 fixedly mounted to the valve member 104 to control actuation of the nozzle control valve 102. The armature 113 is disposed in an armature cavity 115 and arranged such that a gap G is provided between the solenoid and the armature 113. When the solenoid 112 is energised, it overcomes the bias of the spring element 114 and the armature 113 is displaced towards the solenoid and the gap G is closed. The spring member biases the armature 113 away from the solenoid when it is de-energised.

The control chamber 105 of the nozzle control valve 102 is in fluid communication with the high pressure fuel line P_{HIGH} having an operating pressure of up to 3500 bar; and the armature cavity 115 is in fluid communication with the low pressure return drain P_{LOW} having an operating pressure of approximately 6 bar. The valve member 104 is movably mounted in a bore 117 provided between the control chamber and the armature cavity 115. A diametric clearance of approximately 1 μm is formed between the valve member 104 and the bore 117. The valve member 104 and the valve body 103 thereby combine to form a valve stem which seals the high pressure fuel from the low pressure fuel within the nozzle control valve 102. However, due to the large difference in operating pressures between the control chamber 105 and the armature cavity 115, in operation fuel permanently leaks between the valve member 104 and a sidewall of the bore 117 into the armature cavity 115.

To help reduce the movement of fuel along the bore 117 past the valve member 104 and into the armature cavity 115, a gallery 119 is disposed around the valve member 104. In the present embodiment, the gallery 119 is an annular chamber formed in the valve body 103 extending around the circumference of the valve member 104. Alternatively, or in addition, a recess or groove could be formed in the valve member 104 to form the gallery 119. A leak vent 121, in the form of a transverse bore, opens into the gallery 119 and provides a low pressure drain. The leak vent 121 and the gallery 119 are sized to provide an easier pathway for the fuel arriving in the gallery 119 than to continue along the bore 117 into the armature cavity 115.

At least some of the fuel leaking past the valve member 104 can exit through the leak vent 121, for example into the cap nut, thereby bypassing the armature cavity 115. The leak vent 121 thereby diverts the fuel leaking through the bore 117 away from the armature cavity 115, for example to a collection reservoir. The temperature of fuel in the armature cavity 115 can be kept relatively low, thereby reducing the build-up of deposits. The temperature of the fuel exiting through the leak vent 121 will increase due to the reduction in pressure. However, the leak vent 121 by-passes the armature cavity 115, to a cooler, low pressure region of the injector 101. This cooler region reduces the likelihood of deposits forming. If any should form, they are in an area that is not critical to injector performance.

In the present embodiment, fuel leaking past the valve member 104 and travelling along the bore 117 enters the gallery 119 and is then diverted through the leak vent 121. The amount of fuel leaking past the valve member 104 into the armature cavity 115 can thereby be reduced compared to the prior art arrangement. Consequently, the accumulation of fuel deposits in the armature cavity 115 (caused by the elevation of the fuel temperature resulting from the marked reduction in fuel pressure when the leaked fuel enters the armature cavity 115) can be reduced.

The present embodiment has been described as having a gallery 119 extending around the valve member 104. However, the gallery 119 could be omitted to allow fuel leakage to enter the leak vent 121 directly. Optionally, more than one leak vent 121 and/or gallery 119 could be provided.

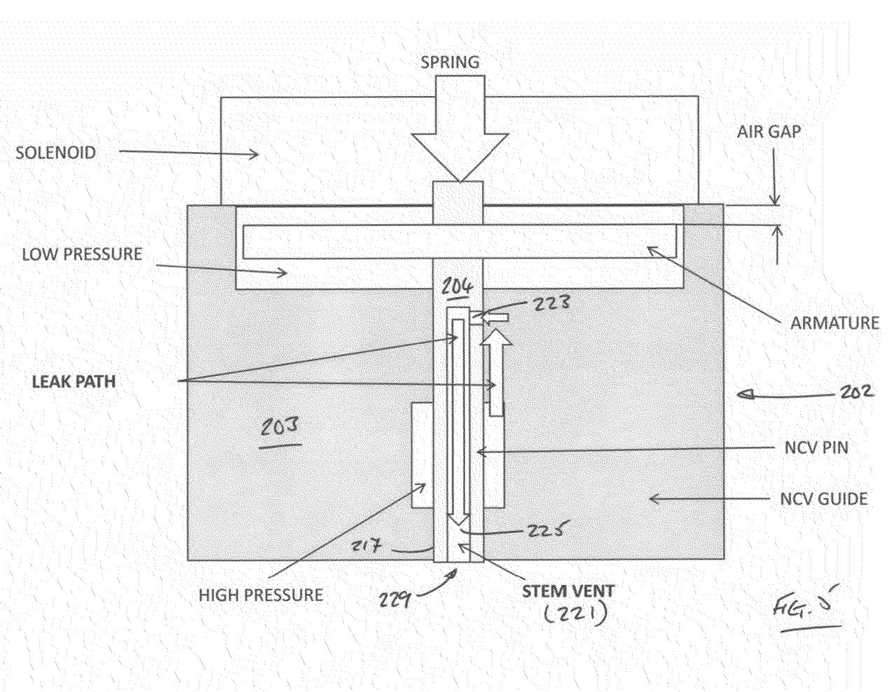

A 3-way nozzle control valve 202 according to a second embodiment of the present invention will now be described with reference to FIG. 5. Like reference numerals will be used for like components, albeit incremented by 100 to aid clarity.

The 3-way nozzle control valve 202 comprises a modified valve member 204 disposed in a bore 217 formed in a valve body 203. The valve member 204 comprises an internal leak vent 221, as illustrated in FIG. 5. The leak vent 221 comprises a transverse inlet 223 which opens into an axial channel 225. The transverse inlet 223 and the longitudinal channel 225 are formed by respective transverse and longitudinal bores. An annular groove (not shown) is optionally formed in an outer sidewall of the valve member 204 coincident with the inlet 223. The annular groove can form a gallery for collecting fuel leaking past the valve member 204 and providing a circumferential inlet to the leak vent 221.

The axial channel 225 extends along a longitudinal axis of the valve member 204 and forms a central outlet 229. The outlet 229 is located in the centre of a second valve for cooperating with a valve seat to control the pressure in the control chamber. Specifically, the second valve selectively opens and closes the low pressure drain P_{LOW} provided in the control chamber 205. The leak vent 221 thereby provides a pathway for fuel leaking past the valve member 204 to the low pressure drain P_{LOW} when the second valve is seated in the second valve seat.

In use, the operation of the fuel injector 201 is the same as the first embodiment. However, rather than direct stem leakage fuel through the valve body 203, the leak vent 221 directs stem leakage fuel through the valve member 204 and out through an existing low pressure drain in communication with the control chamber. It will be appreciated that the valve member 204 could be used in the fuel injector 101 according to the previous embodiment to provide an additional leak vent.

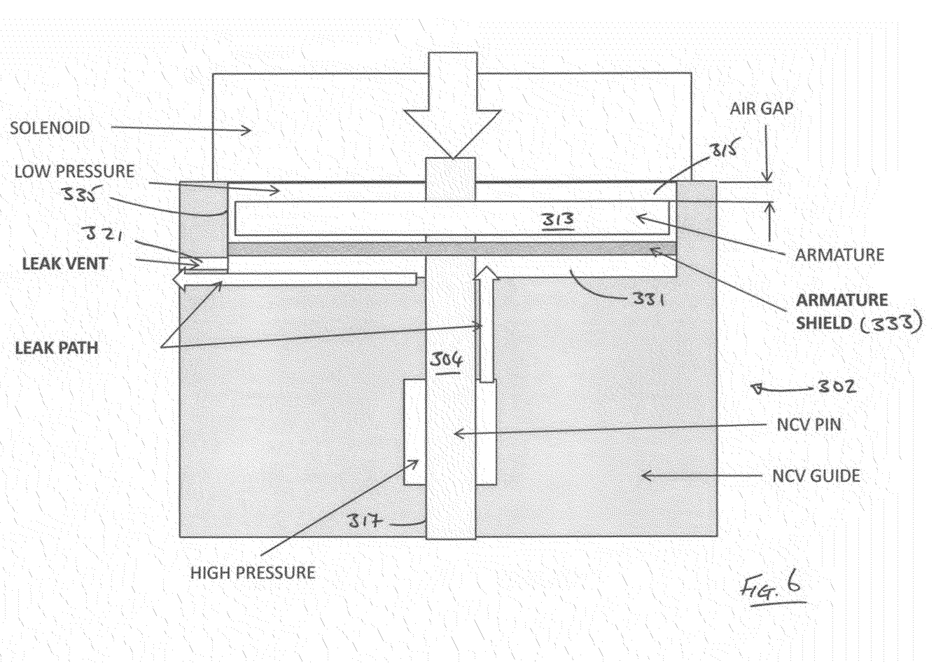

A 3-way nozzle control valve 302 according to a third embodiment of the present invention will now be described with reference to FIG. 6. Like reference numerals will be used for like components described in the first embodiment, albeit incremented by 200 to aid clarity.

The 3-way nozzle control valve 302 comprises a valve member 304 disposed in a bore 317 formed in a valve body 303. A shield 333 is disposed in the armature cavity 315 to inhibit the flow of stem leakage fuel over the armature 313, thereby reducing fuel deposits on the armature 313 and the solenoid. In particular, the shield 333 functions as a partition to form a holding chamber 331 within the armature cavity 315 in which stem leakage fuel can be temporarily held. Moreover, the shield 333 serves to direct at least some of the fuel entering the armature cavity 315 from the bore 317 towards one or more leak vents 321. In the present embodiment the shield 333 is formed from a heat insulating material to reduce the conduction of heat across the shield 333.

The armature 313 is disposed in an armature bore 335 formed in the valve body 303. The shield 333 in the present embodiment is a disc fixedly secured in the armature bore 335. The valve member 304 passes through a central aperture 337 formed in the shield 333. The aperture 337 is a clearance fit on the valve member 304 to accommodate movement of the valve member 304 whilst inhibiting the flow of fuel. In the present embodiment, the leak vent 321 comprises a transverse outlet 339 and/or a longitudinal outlet (not shown). One or more guide means, such as a vane or channel, could be formed in the shield 333 to direct fuel entering the armature cavity 315 towards the leak vent 321.

The shield 333 can be formed from a material having heat shielding properties. The shield 333 could have a sandwich construction, for example to trap an insulating fluid such as air. Alternatively, the shield 333 could comprise a matrix or honeycomb structure to provide the required thermal and mechanical properties. For example, the stiffness of the shield 333 could be altered in different axes by appropriate formation of the matrix or honeycomb structure. An insulating fluid, such as air, could be contained within the structure.

In use, stem leakage fuel enters the armature cavity 315 via the bore 317. The temperature of the fuel is elevated due to the lower pressure within the armature cavity 315. However, the shield 333 directs the fuel away from the armature 313 to reduce fuel deposits on its surface. The stem leakage fuel can exit the holding chamber formed by the shield 333 through the leak vent 321.

In the present embodiment, the shield 333 is fixedly mounted to the valve body 303, but it could equally be mounted to the valve member 315. The movement of the shield 333 could create a pumping effect which could be used to circulate the fuel within the armature cavity 315. The pumping effect could potentially control flow of fuel within the armature cavity 315, for example to promote the flow of fuel towards the leak vent 321.

The shield 333 in the present embodiment is a planar disc. However, the shield 333 could comprise a conical flange or a cylindrical sidewall for cooperating with the armature bore 335. Alternatively, or in addition, a cylindrical section could be provided for cooperating with the valve member 315 to reduce leakage to the armature 313. The shield 333 and leak vent 321 according to the third embodiment could be used in combination with one or both of the leak vents 121, 221 according to the first and second embodiments.

1. A 3-way valve assembly of a fuel injector, the valve assembly comprising:
a movable valve member configured to control an operating pressure in a control chamber;
an armature for actuating the valve member, the armature being disposed in an armature cavity; and
a valve body having a bore in which the valve member is disposed;
wherein the armature cavity is maintained at a pressure which is lower than the operating pressure in the control chamber, so that in use, a permanent leakage of fuel occurs between the valve member and the valve body;
wherein a leak vent is provided for venting fuel leaking through the bore past said valve member;
wherein in use, the leak vent vents at least some of the permanent stem leakage of fuel way from the armature chamber.

2. The 3-way valve assembly as claimed in claim 1, wherein the leak vent is formed in the valve body or the valve member.

3. The 3-way valve assembly as claimed in claim 1, wherein the leak vent comprises an inlet that opens into the bore.

4. The 3-way valve assembly as claimed in claim 3, wherein a gallery is formed in the valve body and/or the valve member, the inlet of said leak vent opening into said gallery.

5. The 3-way valve assembly as claimed in claim 1, wherein the leak vent is in communication with an outlet from a valve chamber.

6. The 3-way valve assembly for a fuel injector as claimed in claim 1,
wherein a partitioning member is disposed in the armature cavity; and wherein the leak vent is in fluid communication with said armature cavity;
wherein, in use, the partitioning member inhibits a flow of stem leakage over the armature.

7. The 3-way valve assembly as claimed in claim 6, wherein the partitioning member is fixedly or movably mounted in the armature cavity.

8. The 3-way valve assembly as claimed in claim 6, wherein said leak vent is provided in fluid communication with a holding chamber formed in the armature cavity by the partitioning member.

9. The 3-way valve assembly as claimed in claim 6, wherein the partitioning member is mounted to the valve member; or the valve member extends through an aperture formed in the partitioning member.

10. The 3-way valve assembly as claimed in claim 6, wherein the partitioning member is configured, in use, to direct fuel leaking past the valve member away from the armature.

11. The 3-way valve assembly as claimed in claim 6, wherein the partitioning member is a heat shield.

12. (canceled)

13. The 3-way valve assembly as claimed in claim 1, wherein the valve assembly is a nozzle control valve for a fuel injector.

14. The 3-way valve assembly as claimed in claim 13, wherein the control chamber is a nozzle control chamber for controlling actuation of a needle valve in the fuel injector.
